(19) United States
(12) Patent Application Publication
(10) Pub. No.: US 2010/0254266 A1
(43) Pub. Date: Oct. 7, 2010

(54) LOW POWER CONSUMPTION REAL-TIME WIRELESS DATA TRANSMITTING METHOD

(75) Inventors: Young-hee Lim, Seongnam-si (KR); Keun-ho Jang, Seoul (KR)

Correspondence Address: CANTOR COLBURN, LLP, 20 Church Street, 22nd Floor, Hartford, CT, 06103, US

(73) Assignee: OPEN SOLUTION CO., LTD., Seoul (KR)

(21) Appl. No.: 12/090,209

(22) PCT Filed: Sep. 27, 2006
(86) PCT No.: PCT/KR2006/003848

§ 371 Date: Jun. 17, 2010

(30) Foreign Application Priority Data
Oct. 14, 2005 (KR) 10-2005-0096991

(51) Int. Cl. H04W 52/02; H04L 12/26

(52) U.S. Cl. 370/241; 370/311

(57) ABSTRACT

The method of transmitting data in real time with low power via a wireless line in which channel status is searched to prevent data loss by transmitting and receiving retransmission a packet every time when there is an interference, and to minimize power consumption necessary for transmission and reception by transmitting and receiving the retransmission packet at a specific period when there is no interference. The method includes: transmitting real time packet data containing reply requesting information from a master to a slave; determining channel status by analyzing whether the master receives the reply packet and reply information; and adjusting the number of times of requesting the reply packet by selectively recording the reply requesting information contained in a control information field of the real time packet data according to the determined channel status. Power consumption due to the transmission and reception of the reply packet can then be reduced.

### BACKGROUND OF THE INVENTION

1. Field of the Invention

The present invention relates to a method of transmitting data in real time with a low power via wireless line, and more particularly, to a method of transmitting data in real time with a low power via a wireless line in which a channel status is searched to prevent data loss by transmitting and receiving a retransmission packet every time when there is an interference, and to minimize a power consumption necessary for transmission and reception by transmitting and receiving the retransmission packet at a specific period when there is no interference.

2. Description of the Related Art

Generally, since, in a wireless real time data transmission system, transmission and reception of data are carried out via a wireless link, transmitted data may be lost or damaged. When there is data loss or data damage, data that is not serviced in real time should be retransmitted. In other words, in a case of a typical real time service such as a voice service, it is not necessary to retransmit vocal data even when the vocal data is lost or damaged. However, in a packet data service, when data is lost or damaged, a correct message is transmitted only by retransmitting the data. Thus, in a communication system in which the data transmission is carried out, data is transmitted by one of various methods of retransmitting data.

In the conventional wireless real time data transmitting system, a method of transmitting data in real time via a wireless line is carried out by which a data transmission terminal transmits control information containing information requiring a reply packet thereon whenever transmitting every packet, and a data receiving terminal, in order to prevent the data loss when there is a channel interference, transmits the reply packet containing the control information required in the retransmission to the data transmission terminal whenever receiving the packet data.

In the channel interference, a rapid data recovery can be carried out by replying of the retransmission control information every time. However, the retransmission control information exists as overhead information in the status that there is no channel interference.

As described above, in the conventional wireless real time data transmission system, since the control information necessary for the retransmission is always transmitted to the data receiving unit every time regardless of the channel status and the data receiving unit loads the control information necessary for the retransmission on the reply packet every time and transmits the reply packet to the data transmitting unit, power consumption is increased.

### SUMMARY OF THE INVENTION

Therefore, the present invention has been made in view of the above problems such as power waste generated by transmitting and receiving the reply packet in the conventional wireless real time data transmitting system, and it is an object of the present invention to provide a low power wireless real time data transmitting method of properly controlling times of transmitting and receiving a reply packet according to whether there is an interference by searching channel status so as to solve the power waste generated by the transmission and reception of the reply packet.

It is another object of the present invention to provide a low power real time data transmitting method of transmitting and receiving a reply packet every time when there is an interference by searching channel status so as to prevent data loss, and of transmitting and receiving the reply packet at a specific period when there is no interference so that power consumption necessary for the transmission and reception can be minimized.

In the low power wireless real time data transmitting method according to the present invention, a device to transmit data is regarded as a master, and a device to receive transmitted data and to transmit a reply packet is defined as a slave.

In accordance with an aspect of the present invention, the above and other objects can be accomplished by the provision of a low power wireless real time data transmitting method in a wireless real time data transmitting apparatus including a master to transmit real time data via a wireless line and a slave to receive the real time data transmitted from the master. The method includes: transmitting real time packet data containing reply requesting information from the master to the slave; determining a channel status by analyzing whether the master receives the reply packet and reply information; and adjusting the number of times of requesting the reply packet by selectively recording the reply requesting information contained in a control information field of the real time packet data according to the determined channel status.

The determination of the channel status is carried out by which the control information contained in the reply packet transmitted from the slave is analyzed, it is determined that there is no channel interference when there is no retransmission request, and the channel interference is determined when the retransmission request information exists in the control information or the reception of the reply packet is failed.

Moreover, the number of requesting the reply packet is adjusted in response to a predetermined specific period in order to reduce a power consumption when there is no channel interference as a result of the determination of the channel status.

Moreover, the number of times of requesting the reply packet is adjusted whenever transmitting the packet when there is the channel interference as a result of the determination of the channel status.

### BRIEF DESCRIPTION OF THE DRAWINGS

FIG. 1 is a block diagram illustrating a wireless real time data transmitting apparatus employing a low power wireless real time data transmitting method according to the present invention;

FIG. 2 is a block diagram illustrating frame structures of a data packet and a reply packet that are transmitted in the present invention;

FIG. 3 is a flowchart illustrating the low power wireless real time data transmitting method according to the present invention;

FIG. 4 is a view illustrating a status of the packet when there is a request for the retransmission of a previous transmittal packet from a slave in the present invention; and

FIG. 5 is a view illustrating a status of the packet when a master device fails the periodical reception of the reply packet.

### DESCRIPTION OF THE PREFERRED EMBODIMENTS

Hereinafter, the preferred embodiments of the present invention will be described in detail with reference to the accompanying drawings.

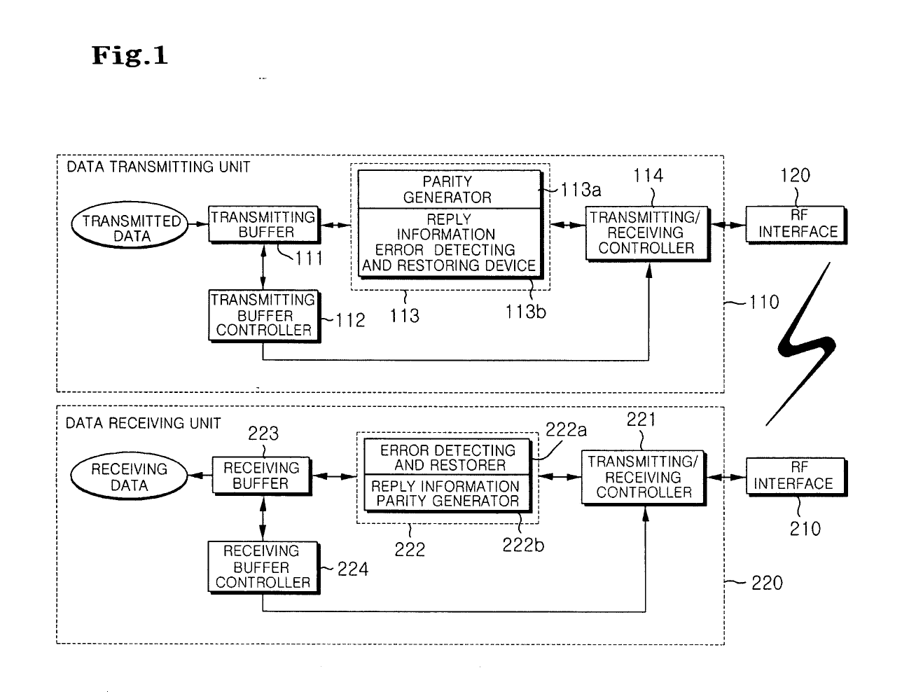

FIG. 1 is a block diagram illustrating a wireless real time data transmitting apparatus employing a low power wireless real time data transmitting method according to the present invention.

Here, a reference numeral 110 is assigned to a data transmitting unit to carry out a real time data transmission, to request a reply packet through a control information field of a transmittal packet when there is a request for a reply packet, to request the reply packet at a specific period when there is no channel interference by analyzing reply information, and to request the reply packet every time every there is packet transmission when there is a channel interference. A reference numeral 120 is assigned to an RF interface connected to the data transmitting unit 110 to modulate the transmitting data outputted from the data transmitting unit 110 into an RF signal and to transmit the RF signal, and to receive and demodulate a reply packet signal transmitted from the exterior to deliver the data transmitting unit 110.

Moreover, a reference numeral 210 is assigned to an RF interface to receive a wireless signal transmitted from the RF interface 120 and to demodulate the received wireless signal into an original signal, and to modulate the transmitted reply packet data into an RF signal. A reference numeral 220 is assigned to a data receiving unit to carry out error correction of data received from the RF interface 210, to analyze the control information recorded in the control information field of the packet, to generate a reply packet when there is a request of a reply packet, and to deliver the reply packet to the RF interface 210.

The data transmitting unit 110 includes a transmitting buffer 111 to temporally store real time transmitting data, and a transmitting buffer controller 112 to control data storing of the transmitting buffer 11, a parity generation for the generating of control information, an error restoration, and a detection of the transmitting data, and to determine whether the transmitting data should be retransmitted and new data should be transmitted according to the control information analyzed from the received reply packet. Moreover, the data transmitting unit 110 includes a data analyzing unit 113 to generate a parity for the error correction and detection of the transmitting data in response to the control of the transmitting buffer controller 112, to analyze the control information of the received reply packet, and to deliver a result signal of the analysis as a signal used to determine whether the transmitting data should be retransmitted to the transmitting buffer controller 112. Here, the data analyzing unit 113 preferably includes a parity generator 113a to generate the parity and a reply information error detecting and restoring device 113b to detect and restore an error of the reply information. The data transmitting unit 110 includes a transmitting/receiving controller 114 in association with the transmitting buffer controller 112 to generate a packet for the transmission of the transmitting data and to receive the reply packet to deliver the reply packet to the data analyzing device 113.

Moreover, the data receiving unit 220 includes a transmitting/receiving controller 221 to receive the wireless real time data transmitted from the data transmitting unit 110 and to transmit the reply packet, and an error correcting and parity generating unit 222 to extract a parity from the real time data, to detect and correct an error of the received data according to the extracted parity, and to generate a parity for the transmission of the reply packet. Here, the error correcting and parity generating unit 222 preferably includes an error detecting and restorer 222a to detect and correct the error of the received data and a reply information parity generator 222b to generate parity for the transmission of the reply packet. Moreover, the error correcting and parity generating unit 222 includes a receiving buffer 223 to temporally store the received data, and a receiving buffer controller 224 to control the receiving buffer to store data, to control the generating of control information of the reply packet and the parity generation for the error correction and detection, and to determine whether the reply packet would be transmitted according to the control information analyzed from the received packet.

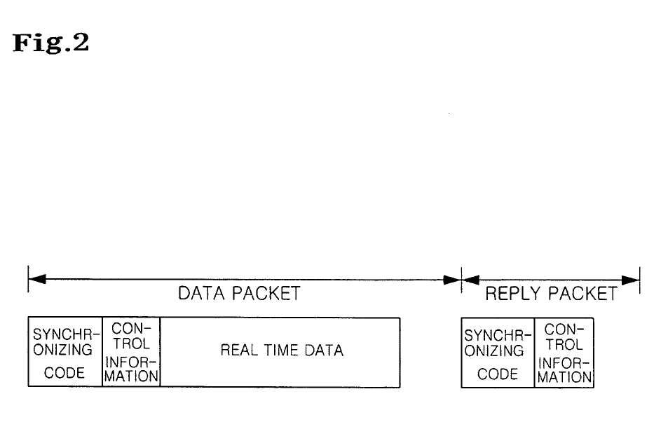

Operation of the low power wireless real time data transmitting method, employed in the wireless real time data transmitting apparatus, will be described in detail with reference to FIG. 2 as follows.

The transmitting buffer controller 112 of the data transmitting unit 110 requests a reply packet to the transmitting/receiving controller 114 to generate control information such that the master determines whether there is channel interference. By doing so, the transmitting/receiving controller 114 generates a data packet containing transmitting data and a parity that pass through and are transmitted through the transmitting buffer 111 and the data analyzing unit 113 sequentially and the reply packet request information requested by the transmitting buffer controller 112. In other words, like the structure of the data packet illustrated in FIG. 2, the transmitting data to be transmitted is recorded in a real data field, data information to indicate what is the parity information and the transmitting data and reply information to indicate whether there is a reply packet request in the control information field, device synchronizing information in a synchronizing field to generate a data packet, and delivery of the data packet to the RF interface 120. Then, the RF interface 120 converts the data packet into an RF signal and transmits the RF signal to the slave.

The RF interface 210 of the slave receives the data packet transmitted from the master to demodulate the same. A path of the demodulated data is controlled by the transmitting/receiving controller 221 of the data receiving unit 220 and the error correction and analysis of the control information of the received data are carried out by the error correcting and parity generating unit 222. The path of the data is controlled by the transmitting/receiving controller 221 of the data receiving unit 220 and the error correction and analysis of the control information of the received data are carried out by the error correcting and parity generating unit 222. The received data in which the error correction has been carried out is stored in the receiving buffer 223 and is outputted to a device to need the received data, and the analyzed control information is delivered to the receiving buffer controller 224. The receiving buffer controller 224 analyzes the delivered control information to deliver a signal of generating a reply packet to the transmitting/receiving controller 221 and to command the error correcting and parity generating unit 222 to generate parity for the reply packer transmission when there is a reply packet request. By doing so, the reply information parity generator 222b of the error correcting and parity generating unit 222 generates the parity for the reply packet transmission and delivers the same to the transmitting/receiving controller 221. The transmitting/receiving controller 221 received the parity for the reply packet transmission records information containing information about the parity for the reply packet transmission and information about the received packet in the control information field, records synchronizing information of indicating device information in a synchronizing code field to generate the reply packet like the structure of the reply packet as illustrated in FIG. 2, and the RF interface 210 modulates the reply packet into the RF signal and transmits the same to the master.

The RF interface 120 of the master receives the reply packet transmitted from the slave to demodulate the same, and the transmitting/receiving controller 114 delivers the demodulated receiving packet to the data analyzing unit 113. The reply information error detecting and restoring device 113b of the data analyzing unit 113 extracts the control information of the demodulated receiving packet and analyzes information such as reception used to determine whether there is a channel interference contained in the control information and delivers the same to the transmitting buffer controller 112.

Then, the transmitting buffer controller 112 determines whether there is the channel interference according to the analyzed control information. Here, the transmitting buffer controller 112 determines that there is the channel interference when the reply packet is not received within a predetermined time period after transmitting the packet containing information of requesting the reply packet.

As a result of the determining whether there is the channel interference, if there is no channel interference, the transmitting buffer controller 112 regards that the retransmission is not required and controls to request the reply packet according to a specific period (this means a period in which a packet requesting period is long). Moreover, if there is the channel interference, the transmitting buffer controller 112 controls to contain and transmit the information of requesting the reply packet in the control information whenever transmitting the packet.

In other words, if the channel interference does not exist, the reply packet is not requested whenever transmitting the packet, but at a predetermined time interval (for example, after transmitting several packets). By doing so, since it is not necessary to transmit the reply packet every time when there is no channel interference, the power consumption, required to transmit the reply packet every time, can be reduced.

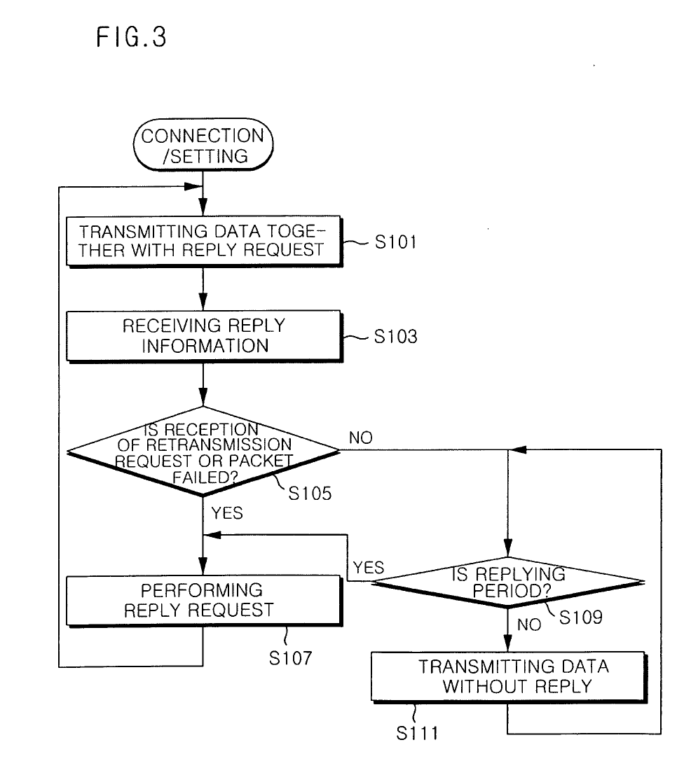

FIG. 3 is a flowchart illustrating the low power wireless real time data transmitting method according to the present invention. In FIG. 3, a reference numeral S indicates processing steps.

As illustrated in FIG. 3, the low power wireless real time data transmitting method according to the present invention includes transmitting S101 real time packet data containing reply requesting information from a master to a slave, determining S103 and S105 channel status by analyzing whether the reply packet is received and reply information by the master, and adjusting S107, S109, and S111 the number of times of requesting the reply packet by selectively recording the reply requesting information contained in the control information field of the real time packet data.

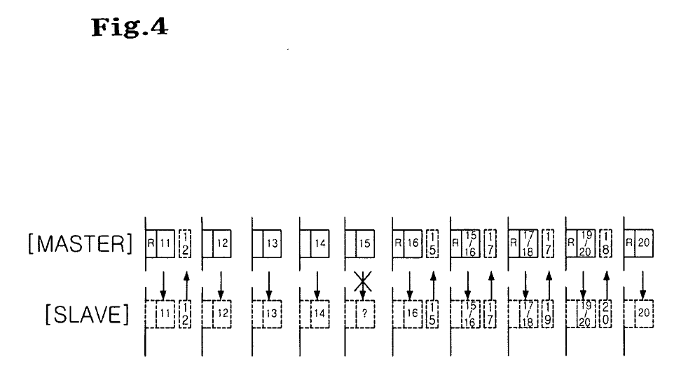

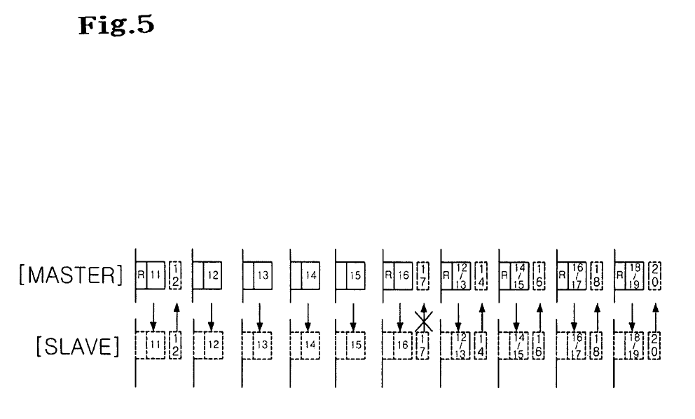

Operation of the low power wireless real time data transmitting method according to the present invention will be described in detail with reference to FIGS. 4 and 5 as follows.

Firstly, in the step S101, the transmitting/receiving controller 114 of the master generates the real time packet data containing the reply requesting information of determining whether there is the channel interference and transmits the same to the slave.

In the step S103, the reply information transmitted from the slave is received, and the reply information is analyzed and whether the reply packet is received is checked to determine the channel status in the step S103. In other words, the control information contained in the reply packet transmitted from the slave is analyzed. It is determined that there is no channel interference when there is no retransmission request and it is determined that there is channel interference when the retransmission request is in the control information or the reception of the reply packet is failed.

If it is determined that there is channel interference, like the step S105, information of requesting the reply packet is loaded on the control information whenever transmitting the packet and the packet is transmitted. Thus, if there is channel interference, the slave should generate the reply packet and transmit the same to the master whenever receiving the packet.

On the other hand, if there is no channel interference, like the steps S109 and S111, the number of times of the requesting the reply packet is adjusted in response to the predetermined specific period in order to reduce the power consumption.

In other words, if there is no channel interference, the reply packet is not requested whenever transmitting the packet, but at a predetermined time interval (for example, after transmitting several packets). By doing so, since is not necessary to transmit the reply packet every time when there is no channel interference in the slave, the power consumption required to transmit the reply packet every time can be reduced.

FIG. 4 is a view illustrating a status of the packet when there is a request for the retransmission of a previous transmittal packet from a slave in the present invention, and FIG. 5 is a view illustrating a status of the packet when a master device fails the periodical reception of the reply packet. Here, a packet indicated by “R” represents a packet, to be transmitted, on which the reply request is loaded. As illustrated in FIG. 5, when the master fails to receive the reply packet periodically, the retransmission request is transmitted until data can be substantially loaded at a data transmission rate.

As described above, in the present invention, the power consumption can be reduced by reducing the transmission and reception of a specific packet (for example, the reply packet). A rate of the power consumption required for the transmission and reception reduced according to the reply requesting period can be expressed by a formula as follows.

Power consumption saving rate (%)=(period−1)/(overall length of a packet*period)*100

In other words, if assuming that the length of the reply packet is ⅓ of the length of the data packet, since the length of the data packet is 3 when the length of the reply packet is 1 (one), the overall length of the packet is set to 4, and, if the reply requesting period is set to 2, the power consumption required for the transmission and reception can be reduced by 12.5%. Moreover, the power consumption can be reduced by 16.7% when the reply requesting period is set to 3, and by 18.75% when the reply requesting period is set to 4. As such, although the power consumption can be reduced by 25% as much as possible by increasing the reply requesting period, since a buffer prepared for the retransmission request is increased as much

as the reply requesting period is increased, it is preferred to obtain and employ an optimal value according to an applied system.

As described above, although the present invention is described by an embodiment in which the master transmits the control information and the real time data and the slave transmits simple control information, the present invention is not limited to this.

For example, it is possible that a system in which the master transmits the simple control information and the slave transmits a great deal of data can be applied to a system in which the transmission of the master is controlled by the control information of the slave through a simple modification. In another case, the power consumption can be more reduced than that proposed in the embodiment of the present invention by which both of the master and the slave transmit the control information to control the transmission of the other party.

As described above, according to the present invention, the channel status is searched and the number of times of transmission and reception of the reply packet is properly controlled according to whether there is the channel interference, so that the power waste generated by the transmission and reception of the reply packet can be solved.

Moreover, when the channel status is searched and there is the channel interference, the transmission and reception of the retransmitting reply packet is carried out every time to prevent the data from being lost, and the power consumption required for the transmission and reception can be minimized by transmitting and receiving the retransmitting reply packet at a specific period when there is no channel interference.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A low power wireless real time data transmitting method in a wireless real time data transmitting apparatus comprising a master to transmit real time data via a wireless line and a slave to receive the real time data transmitted from the master, the method comprising:
transmitting real time packet data containing reply requesting information from the master to the slave;
determining a channel status by analyzing whether the master receives the reply packet and reply information; and
adjusting the number of times of requesting the reply packet by selectively recording the reply requesting information contained in a control information field of the real time packet data according to the determined channel status.

2. The low power wireless real time data transmitting method according to claim 1, wherein the determination of the channel status is carried out by which the control information contained in the reply packet transmitted from the slave is analyzed, it is determined that there is no channel interference when there is no retransmission request, and the channel interference is determined when the retransmission request information exists in the control information or the reception of the reply packet is failed.

3. The low power wireless real time data transmitting method according claim 1, wherein the number of requesting the reply packet is adjusted in response to a predetermined specific period in order to reduce a power consumption when there is no channel interference as a result of the determination of the channel status.

4. The low power wireless real time data transmitting method according to claim 1, wherein the number of times of requesting the reply packet is adjusted whenever transmitting the packet when there is the channel interference as a result of the determination of the channel status.

5. The low power wireless real time data transmitting method according to claim 3, wherein the number of times of requesting the reply packet is adjusted whenever transmitting the packet when there is the channel interference as a result of the determination of the channel status.
